(19) United States
(12) Patent Application Publication
(10) Pub. No.: US 2017/0039195 A1
(43) Pub. Date: Feb. 9, 2017

(54) HAPPY FACTOR SERVICE SYSTEM AND METHOD OF PROVIDING HAPPY FACTOR SERVICE USING THE HAPPY FACTOR SERVICE SYSTEM

(71) Applicant: Young Hee RO, Gyeonggi-do (KR)

(72) Inventor: Young Hee RO, Gyeonggi-do (KR)

(21) Appl. No.: 14/821,413

(22) Filed: Aug. 7, 2015

(51) Int. Cl. G06F 17/30

(52) U.S. Cl. CPC G06F 17/3053; G06F 17/30867; G06F 17/30528; G06F 17/30598

(57) ABSTRACT

Provided are a happy factor service system which collects, analyzes, and processes happy factor information for various individuals to provide a corresponding individual with a happy factor service and a method of providing the happy factor service using the system. The system includes a happy factor management server and a plurality of personal terminals connected thereto through a wired or wireless communication network, comprising an information input module, a database module which stores data obtained from the information input module and each module and provides data necessary for each module, a data analyzing module which analyzes the information obtained from the information input module, a happy factor extraction module which extracts a happy factor from the data analyzed by the data analyzing module, and a guideline generating module which compares the happy factor extracted by the happy factor extraction module with standard data and provides a guideline.

### FIELD

The present disclosure relates to a happy factor service system and a method of providing a happy factor service using the happy factor service system in which happy factor information which is a criterion of happiness of various individuals is collected, analyzed, and processed to provide the happy factor service to a corresponding person.

### BACKGROUND

A general meaning of a happy factor is an index which indicates how happy a person is and is measured by him or herself.

As a representative happy factor calculation method, a happy formula is made and disclosed by Rothwell, a psychologist, and Cohen, a life coach, in 2002.

They have experimented with 1000 males and females to choose five cases of allowing them to be happier from 80 cases for 18 years. As a result, it was insisted that the happiness was determined according to three elements such as personal (P) that indicates personal characteristics such as a view of life, adaptability, and flexibility, existence (E) that indicates survival conditions such as health, money, and human relations, and higher order (H) that indicates higher-level states such as ambition, self-respect, expectation, and humor. Among the three elements, they determined that E that is survival conditions is five times more important than P that is personal characteristics and H that is higher-level states is three times more important than P and formulated the happy factors as P+(5×E)+(3×H).

Recently, the happy factor is emblazed not only as being a personal signification but also as a national point of view.

Not only economic values such as gross domestic product (GDP) but also the happiness of humans and the quality of life such as satisfaction with life, expectations of future, the unemployment rate, pride, hope, and love are comprehensively considered to calculate the index. GDP is generally used as an index for checking the economic activity of a nation but has been criticized for simply calculating an amount of economic activity but not reflecting extrinsic effects in addition to the economy or the quality of life. For this, it has been continuously insisted to make a new index including the quality of life and sustainable development to replace GDP. One of new social welfare indices replacing growth, which draws attention of the world, is gross national happiness (GNH). Such happy factor is fully introduced by the government of Bhutan as an example.

In the case of Bhutan, GNH factor is formed of nine normative areas considered as elements for forming a level of general happiness and social welfare of Bhutanese. The nine factors include psychological wellbeing, time use, community vitality, culture, health, education, ecological diversity, living standards, and good governance. In drafting the GNH factor, each area has the same weighted value and is evaluated using several indices. Items which do not change as time passes, have a high response rate in investigation, and do not have a strong correlation are selected as the indices.

However, since the concept of happy factor has strong multidisciplinary and integral properties, a definition thereof may differ depending on determining a range of field. Also, actually there is no systemic online service for proving individuals with continuous management related thereto.

Korean Patent Publication No. 2003-0000493 discloses a service method of NHI synthetic management using communication network, which relates to a national happiness index (NHI) integrated management system and service method using a communication network such as the Internet and a telephone network. The method includes setting classification of items for evaluating an NHI, survey items, and criteria of grades and coding the evaluation items and the survey items while providing an NHI service is provided to an NHI evaluation requester, and participant who joins to be a member through a communication network, introducing the participant who takes part in a survey when the requester requests an NHI evaluation, providing the introduced participant with a survey item corresponding to a requested evaluation item, computing the total of grades for respective detailed elements of data in response to the provided survey time and comparatively analyzing it based on the criteria of grades, and automatically computing an NHI in real time, and searching for and transmitting corresponding NHI data to the user when the user requests NHI data. Herein, real-time data of evaluating individual happiness indices with respect to various forms of products or services provided or sold for each nation, public enterprise, public agency, or private enterprise are integrated-managed. However, such method is limited to a simple total computation range but neither guides nor manages happiness indices of users.

### SUMMARY

A happy factor may be divided and defined into ten elements such as a social happy factor, an occupational happy factor, a spiritual happy factor, a physical happy factor, an intellectual happy factor, an emotional happy factor, an environmental happy factor, a financial happy factor, a mental happy factor, and a medical happy factor.

It is an aspect of the present invention to provide a happy factor service system to maximally satisfy various clients by collecting, analyzing, and processing happy factor information for respective various clients with respect to the ten elements of the happy factor and providing the happy factor information for each corresponding client and a method of providing the happy factor information using the system and to improve the quality of life of a user by managing a happy factor through feedback.

According to an aspect of the present invention, there is provided a happy factor service system including a happy factor management server 100 and a plurality of personal terminals 200, 300, 400 . . . connected thereto through a wired or wireless communication network, in which the happy factor management server 100 includes an information input module 110, a database module 120 which stores data obtained from the information input module 110 and each module and provides data necessary for each module, a data analyzing module 130 which analyzes the information obtained from the information input module 110, a happy factor extraction module 140 which extracts a happy factor from the data analyzed by the data analyzing module 130, and a guideline generating module 150 which compares the happy factor extracted by the happy factor extraction module 140 with standard data and provides a guideline.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram of a happy factor service system according to one embodiment of the present invention;

FIG. 2 is a detailed block diagram of a happy factor management server shown in FIG. 1;

FIG. 3 is a flowchart illustrating a method of providing customized happy factor information according to one embodiment of the present invention;

FIG. 4 is a view illustrating a classification example of classifying object types (S300) according to one embodiment of the present invention; and

FIG. 5 is a view illustrating an operation of calculating a weighted value for each area of standard information according to the object types and received input information.

### DETAILED DESCRIPTION

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

A happy factor service system and a method of providing a happy factor service using the system according to one embodiment of the present invention will be described with reference to the attached drawings.

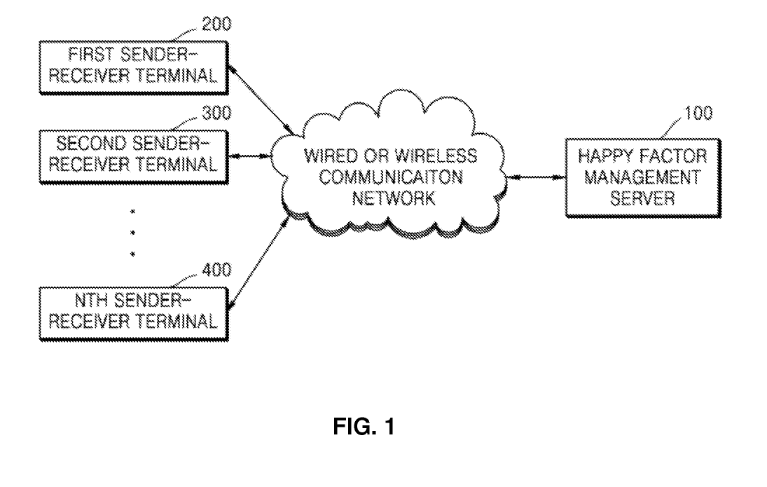

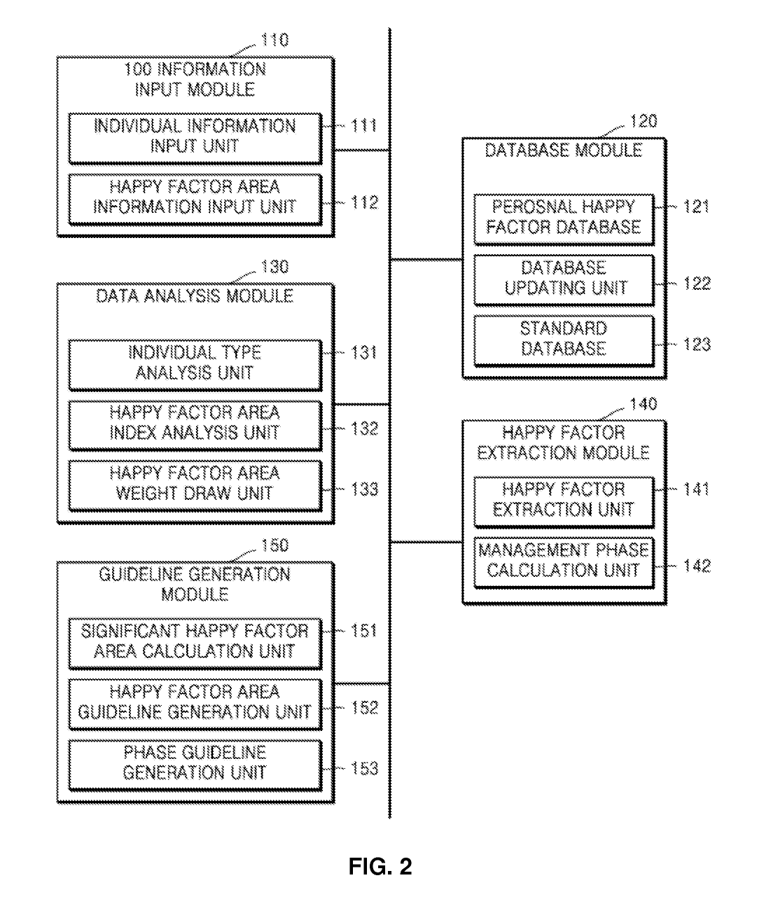

FIG. 1 is a block diagram of the happy factor service system according to one embodiment of the present invention. FIG. 2 is a detailed block diagram of a happy factor management server 100 shown in FIG. 1.

The system includes the happy factor management server 100 and a plurality of personal terminals 200, 300, 400 . . . connected thereto through a wired or wireless communication network. The happy factor management server 100 includes an information input module 110, a database module 120 which stores data obtained from the information input module 110 and each module and provides data necessary for each module, a data analysis module 130 which analyzes the information obtained from the information input module 110, a happy factor extraction module 140 which extracts a happy factor from the data analyzed by the data analysis module 130, and a guideline generating module 150 which compares the happy factor extracted by the happy factor extraction module 140 with standard data and providing a guideline.

There is no limitation on the personal terminals 200 for transmitting or receiving the happy factor information. The personal terminals 200 may be smart phones, personal computers, and IPTVs. For easy identification of a user, a phone number of a smart phone may be identification information, a personal computer may be used through logging on a homepage of the happy factor management server 100 and checking identification information and a password, and an IPTV may be used through logging on the homepage of the happy factor management server 100 and checking identification information and a password. In addition to the identification method described above, various identification methods may be applied.

The information input module 110 may include an individual information input unit 111 for inputting individual basic information such as gender and age of a person and a happy factor area input unit 112 for inputting information for each happy factor area.

Data input from the information input module 110 is stored in the database module 120. The database module 120 may include a personal happy factor database 121 which stores the individual basic information obtained from the individual information input unit 111 and the information for each happy factor area obtained from the happy factor area input unit 112, a standard database 122 which stores previously built standard information, and a data updating unit 123 for updating the respective databases.

The data analysis module 130 may include an individual type analysis unit 131 which analyzes an individual type based on data obtained from the individual information input unit 111, a happy factor area index analysis unit 132 which analyzes an index for each happy factor area based on data obtained from the happy factor area input unit 112, and a happy factor area weight draw unit 133 for giving a weighted value according to an analysis result of the individual type analysis unit 131 to the index for each happy factor area analyzed by the happy factor area index analysis unit 132.

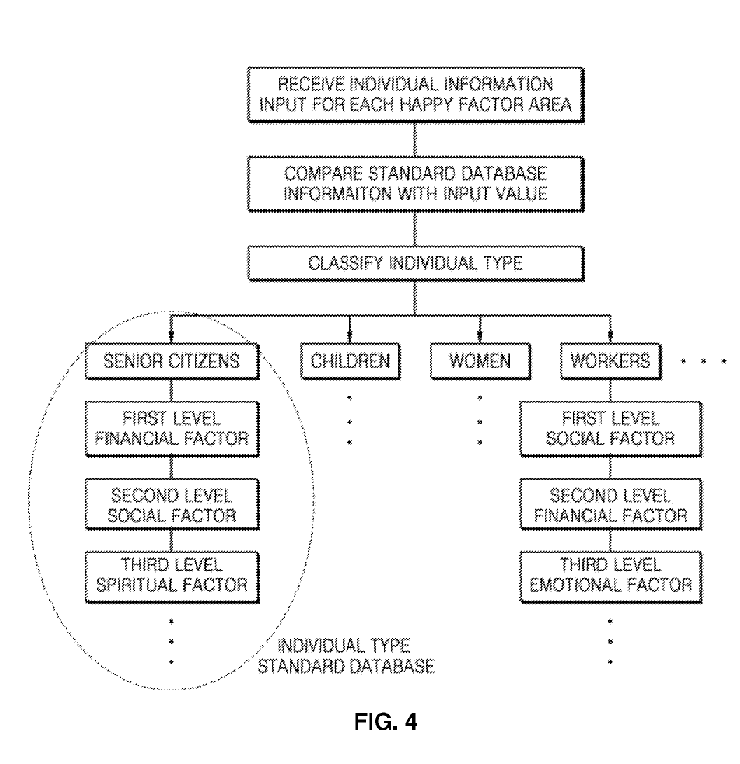

As shown in FIG. 4, a type analysis of the individual type analysis unit 131 is to classify individuals (users) into seniors, employees, women, children, and general persons and to diagnose each person. A reason of this, it is necessary for general persons to differently diagnose/evaluate/set and manage a target from the senior citizens, women, and children and to also differently apply balance management, ideal management, and source management therefrom.

As shown in FIG. 4, a financial factor is of greatest importance in the case of the senior citizens and a social factor is of great importance in the case of workers. The importance is merely an example and varies according to a personal tendency of the user using the system, a tendency of a user group, and social/timely environments. Such changes become rapidly reflected in the system according to the embodiment of the present invention due to a feedback operation which will be described below.

As described above, since a prominent valuable item differs according to each class, all items may not be uniformly evaluated. That is, in the case of the senior citizens who regard the financial factor as important, even when the same scores are given to both the financial factor and a spiritual factor, it is necessary to give a weighted value to allow the score of the financial factor to be more greatly reflected in a total happy factor.

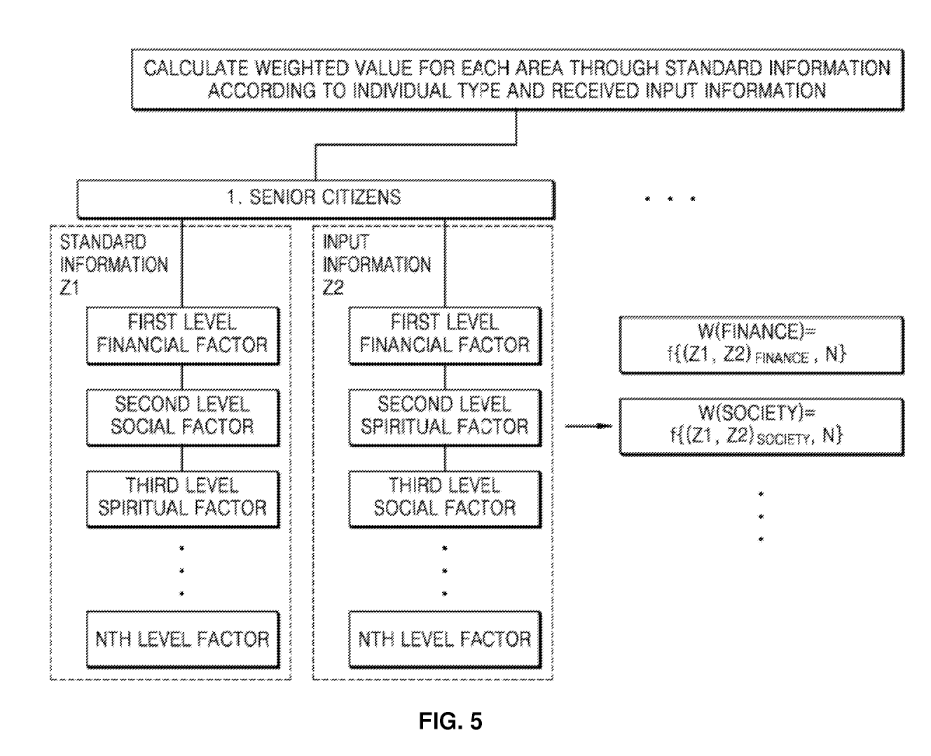

As shown in FIG. 5, a weight calculation of the happy factor area weight draw unit 133 may be performed by considering both standard information Z1 and input information Z2 at the same time.

That is, a weighted value W may be determined according to a function value of a factor Z1 of standard information, a factor Z2 of input information, and a total factor number N.

[Weight value W=f{(Z1,Z2),N}].

Here, a formula of the function f may be flexibly applied according to characteristics of the user group and a social natural environment in which a corresponding system is operated.

For example, in an environment in which the personal tendency is more important, the input information is two times more important than the standard information, thereby setting as follows.

f{(Z1,Z2),N}=N/(2Z1+Z2).

That is, the formula of calculating a weighted value is not limited to the example described above but may be variously applied according to a personal, social/natural environment.

The happy factor extraction module 140 may include a happy factor extraction unit 141 which extracts a happy factor by reflecting a result of the happy factor area weight draw unit 133 in the analysis result of the individual type analysis unit 131 and a management phase calculation unit 142 for obtaining a management reference of the extracted happy factor.

In the calculation of the management phase performed by management phase calculation unit 142, the happy factor of the user may be classified into a social happy factor, an occupational happy factor, a spiritual happy factor, a physical happy factor, an intellectual happy factor, an emotional happy factor, an environmental happy factor, a financial happy factor, a mental happy factor, and a medical happy factor. This will be provided as a table as follows.

TABLE 1

| | | | | |
|---|---|---|---|---|
| | Diagnosis/ | | | |
| | evaluation/ | | | |
| | target | Balance | Ideal | Source |
| | setting and | manage- | manage- | manage- |
| Division | management | ment | ment | ment |

| | |
|---|---|
| Happy | Social |
| factor | happy factor |
| items | Occupational |
| | happy factor |
| | Spiritual |
| | happy factor |
| | Physical |
| | happy factor |
| | Intellectual |
| | happy factor |
| | Emotional |
| | happy factor |
| | Environ- |
| | mental |
| | happy factor |
| | Financial |
| | happy factor |
| | Mental |
| | happy factor |
| | Medical |
| | happy factor |

Here, a diagnosis/evaluation/target setting and management item is a phase in which a physical, mental, and social state of a person in an aspect of the happy factor are recognized and a personal target is set.

Also, a balance management item is a phase that is a health exercise influence effect factor for maintaining a normal range provided by a happy factor diagnosis report/score sheet and controlling various risks such as smoking and drinking.

Also, an ideal management item is a sustainable phase/field target setting management accomplishment forwarding phase to reach personal happiness and an ideal happy factor world.

Also, a database source management item is a happy factor IT industrial database (links, incentives, analysis, and big data) utilization phase.

Also, the items shown in Table 1 may be divided and positioned according to personal characteristics into senior citizens, children, women, employees, general persons, serious patients who are not movable and stay in a hospital, people who can move while being helped by a third party, people who can live their life for themselves, people who are aggressive for health care, and athletes who are healthy to take part in athletics competitions.

Meanwhile, among them, the physical happy factor may be formed as following Table 2.

TABLE 2

| | | Some- | | |
|---|---|---|---|---|
| Items | Rare | times | Mostly | Always |
| I maintain a desirable weight. | 1 | 2 | 3 | 4 |
| I do an active exercise such as | 1 | 2 | 3 | 4 |
| walking. | | | | |
| I do exercise to strengthen muscles | 1 | 2 | 3 | 4 |
| and joints. | | | | |
| I stretch before and after an intense | 1 | 2 | 3 | 4 |
| workout. | | | | |
| I feel well in physical condition. | 1 | 2 | 3 | 4 |
| I sleep for 7-8 hours every day. | 1 | 2 | 3 | 4 |
| My body can prevent contagious | 1 | 2 | 3 | 4 |
| disease due to my strong immune | | | | |
| system. | | | | |
| I quickly restore from sickness or | 1 | 2 | 3 | 4 |
| injury. | | | | |
| I have a lot of energy without | 1 | 2 | 3 | 4 |
| excessive fatigue. | | | | |
| I seek expert advice. | 1 | 2 | 3 | 4 |

The social happy factor may be formed as following Table 3.

TABLE 3

| | | Some- | | |
|---|---|---|---|---|
| | Rare | times | Mostly | Always |
| People have a favorable image of me. | 1 | 2 | 3 | 4 |
| I am open and honest and get along | 1 | 2 | 3 | 4 |
| well with others. | | | | |
| I like various social activities. | 1 | 2 | 3 | 4 |
| I would like to comport myself with | 1 | 2 | 3 | 4 |
| better behavior when a problem | | | | |
| occurs in interaction with others. | | | | |
| I get along well with my family. | 1 | 2 | 3 | 4 |
| I listen well to others. | 1 | 2 | 3 | 4 |
| I am open, loving, and active in | 1 | 2 | 3 | 4 |
| responsible relations. | | | | |
| I have one whom I could tell my | 1 | 2 | 3 | 4 |
| personal feeling. | | | | |
| I consider the feeling of others and | 1 | 2 | 3 | 4 |
| do not act in a way of hurting or in | | | | |
| a selfish way. | | | | |
| Before tell others, I consider what | 1 | 2 | 3 | 4 |
| to say and how to say. | | | | |

The emotional happy factor may be formed as following Table 4.

TABLE 4

| | | Some- | | |
|---|---|---|---|---|
| | Rare | times | Mostly | Always |
| I easily find a laughing matter | 1 | 2 | 3 | 4 |
| in my life. | | | | |
| I do not depend on alcohol to | 1 | 2 | 3 | 4 |
| forget my problem. | | | | |
| I can express my feeling not like | 1 | 2 | 3 | 4 |
| an idiot. | | | | |
| I know how to do to others without | 1 | 2 | 3 | 4 |
| opposition or harm when I am angry. | | | | |
| I have many worries and distrust | 1 | 2 | 3 | 4 |
| others. | | | | |
| When I am under stress, I recognize | 1 | 2 | 3 | 4 |
| this and take a rest through exercise, | | | | |
| a quiet time or other activities. | | | | |
| Other people like me about a favor- | 1 | 2 | 3 | 4 |
| able impression of me and who I am. | | | | |
| When I am angry, I talk about it to | 1 | 2 | 3 | 4 |
| others and would like to be active | | | | |
| about solving it. | | | | |
| I am flexible and can control in | 1 | 2 | 3 | 4 |
| an active way to adapt or | | | | |
| reconstruct. | | | | |
| My friends think about me stable | 1 | 2 | 3 | 4 |
| and well controlling emotions. | | | | |

The environmental happy factor may be formed as following Table 5.

TABLE 5

| | | Some- | | |
|---|---|---|---|---|
| | Rare | times | Mostly | Always |
| I worry about environmental pollu- | 1 | 2 | 3 | 4 |
| tion and would like to aggressively | | | | |
| protect natural resources. | | | | |
| I report one who harms the environ- | 1 | 2 | 3 | 4 |
| ment on purpose. | | | | |
| I recycle waste. | 1 | 2 | 3 | 4 |
| I recycle plastic, paper, bags, and | 1 | 2 | 3 | 4 |
| nickel silver. | | | | |
| I cast a vote for an eco-friendly | 1 | 2 | 3 | 4 |
| candidate in an election. | | | | |
| I fill in a leader elected with | 1 | 2 | 3 | 4 |
| respect to an environmental problem. | | | | |
| I consider an amount and wrapper of | 1 | 2 | 3 | 4 |
| a product when I buy food. | | | | |
| I sometimes try to buy a recycled | 1 | 2 | 3 | 4 |
| product. | | | | |
| I try to use both sides of a sheet | 1 | 2 | 3 | 4 |
| of paper. | | | | |
| I would not like to waste water when | 1 | 2 | 3 | 4 |
| I am brushing my teeth, shaving, and | | | | |
| bathing. | | | | |

The spiritual happy factor may be formed as following Table 6.

TABLE 6

| | | Some- | | |
|---|---|---|---|---|
| | Rare | times | Mostly | Always |
| I believe that a life is a precious | 1 | 2 | 3 | 4 |
| present to breed up. | | | | |
| I have a time to enjoy nature and | 1 | 2 | 3 | 4 |
| beauty around me. | | | | |
| I have a time to think alone about | 1 | 2 | 3 | 4 |
| who I am, what my value is, where I | | | | |
| am, and where to go. | | | | |
| I believe greater power than great | 1 | 2 | 3 | 4 |
| power such as God. | | | | |
| I am attentive and do somebody a | 1 | 2 | 3 | 4 |
| favor without expecting something. | | | | |
| I feel sadness for people who suffer | 1 | 2 | 3 | 4 |
| and would like to help them in | | | | |
| tough times. | | | | |
| I am in contact with lives of the | 1 | 2 | 3 | 4 |
| lives of others in a positive way. | | | | |
| I work for the peace of personal | 1 | 2 | 3 | 4 |
| relations in a local community | | | | |
| and a greater world. | | | | |
| I am satisfied with whom I am. | 1 | 2 | 3 | 4 |
| I move to experience the taste of | 1 | 2 | 3 | 4 |
| life as much as possible. | | | | |

The mental happy factor may be formed as following Table 7.

TABLE 7

| | | Some- | | |
|---|---|---|---|---|
| | Rare | times | Mostly | Always |
| I tend to act impulsively without | 1 | 2 | 3 | 4 |
| thinking about a result. | | | | |
| I would like to lean from my mis- | 1 | 2 | 3 | 4 |
| takes and to act in a different | | | | |
| way next time. | | | | |
| I go in a direction or follow a | 1 | 2 | 3 | 4 |
| recommended guideline. Also, I act | | | | |
| to maintain the safety of others | | | | |
| and me. | | | | |
| I consider an alternative plan | 1 | 2 | 3 | 4 |
| before determination. | | | | |
| I am ready to be on the alert and | 1 | 2 | 3 | 4 |
| prepare against a change of life | | | | |
| and ready to accept a challenge. | | | | |
| I do my thoughtless action with | 1 | 2 | 3 | 4 |
| better feeling. | | | | |
| I am active about learning all that | 1 | 2 | 3 | 4 |
| I can do with respect to a product | | | | |
| and service before decision. | | | | |
| I control the time rather than being | 1 | 2 | 3 | 4 |
| controlled by the time. | | | | |
| My friends and family put their | 1 | 2 | 3 | 4 |
| trust in me. | | | | |
| I think about my story and check a | 1 | 2 | 3 | 4 |
| truthful evidence of my awareness | | | | |
| and feeling. | | | | |

A checklist according the formation as described above will be formed as following Table 8.

TABLE 8

| | Ideal score | Your score |
|---|---|---|
| Physical happy factor | 40 | |
| Social happy factor | 40 | |
| Emotional happy factor | 40 | |
| Environmental happy factor | 40 | |
| Spiritual happy factor | 40 | |
| Mental happy factor | 40 | |

Here, in the case of the respective happy factors in Table 8, for example, a score from about 35 to about 40 may be excellently evaluated excellent, a score from about 30 to about 35 may be evaluated good although there is room for improvement, a score from about 20 to about 30 indicates there are health risks which should be improved, and a score less than 20 indicates there are serious health risks.

Also, through this, it is possible to provide ways of compensate for parts which are personal defects in Table 2 to Table 7. That is, in addition to simple comparison between standard data of a comparison group of the standard information database 122 and the input data of the user, analyzed happy factor information is compared. When happy factor personal information falls short of meeting happy factor standard information, a guideline for managing a balance is generated as a happy factor customized information to be closer to the happy factor standard information. When the happy factor personal information is more than the happy factor standard information, a guideline for an ideal management more than the happy factor standard information is generated as the happy factor customized information.

Also, the diagnosis/evaluation/target setting and management item, for example, may be shown as following Table 9.

TABLE 9

| | | |
|---|---|---|
| Item | Score | Evaluation Criteria |

| | | |
|---|---|---|
| Mental | Depression | GDS-K survey, counsel |
| diagnosis | Stress | survey, stress measuring device |
| Physical | Obesity (BMI) | Height, weight, body composition |
| diagnosis | | measurer |
| | Obesity | Tapeline, body composition |
| | (abdomen) | measurer |
| | Obesity (body | Body composition measurer, |
| | fat percentage) | skinfold-caliper |
| | Obesity | Skinfold-caliper |
| | (subcutaneous fat) | |
| | Obesity (body | Body composition measurer |
| | fat mass) | |
| | Physical strength | Physical strength checker |
| | National people | Body composition analysis, issue |
| | physical strength | a certificate according to |
| | | check physical strength |
| | Physical | Blood pressure, blood sugar, |
| | examination | waistline, body composition, |
| | | hearing, electrocardiogram, bone |
| | | density |
| | | Vein aging, psychology, |
| | | nonsmoking, sense of balance |
| | | check, accurate physical strength |
| | | check |
| | Musculoskeletal | Musculoskeletal checkup |
| | system | |
| Social | Character | Examination through survey |
| diagnosis | classification | |

When a value of the diagnosis/evaluation/target setting and management item is determined, a personal balance management target value which may be allowed to be obtained with a set target time may be determined. Meanwhile, the ideal management item is a value built in the happy factor standard information database 122 in which ideal management values are determined for respective seniors, employees, women, children, and general persons. The ideal management value is compared with information stored in the personal information database 140 and customized happy factor information is to be provided.

For example, ideal management values of a height and weight of a person are compared with present values thereof to allow the weight to be increased or reduced not to harm to a human body. Depending on one of which the corresponding person is a senior, employee, woman, child, or a general person, appropriate exercise therapy or dietary therapy as the customized happy factor information may be provided.

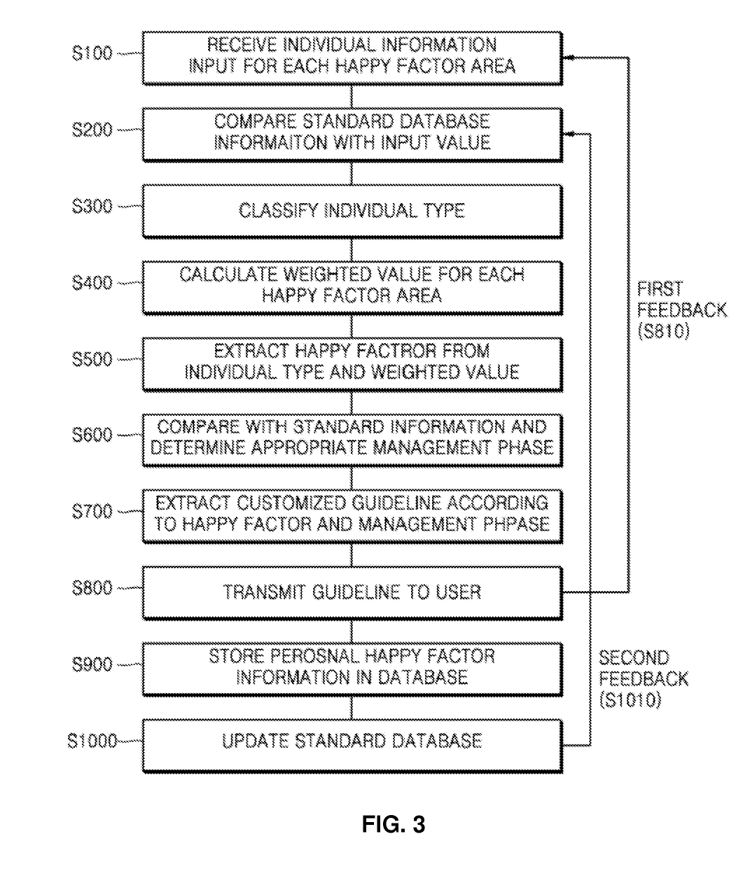

Also, according to the embodiment of the present invention, there is provided a method of providing a happy factor service using the happy factor service system described above. FIG. 3 is a flowchart illustrating a method of providing customized happy factor information according to one embodiment of the present invention.

The method of providing the happy factor service for a user includes an information receiving operation (S100) of receiving information input for each happy factor area, a standard information comparison operation (S200) of comparing information of a standard database with an input value, an individual classification operation (S300) of classifying types of individuals according to inputted individual information, a weighted value calculation operation (S400) of giving a weighted value to each happy factor area according to a classified individual type, a happy factor extraction operation (S500) of extracting a happy factor according to the classified individual type and a calculated weighted value for each area, a management phase determination operation (S600) of determining an appropriate management phase by comparing the extracted happy factor with standard information of the standard information database 122 of the database module 120, a guideline extraction operation (S700) of extracting a customized guideline according to the extracted happy factor and the determined management phase, a guideline transmission operation (S800) of transmitting the extracted guideline to the user, a personal happy factor information storage operation (S900) of storing personal happy factor information in the personal happy factor database 121, and a standard database updating operation (S1000) of updating the standard database 122 by reflecting the stored personal happy factor information.

The respective operations are performed by respective corresponding modules of the happy factor management server 100. The operations may be sequentially performed, but the several operations may be performed at the same time.

In the guideline transmission operation S800 of transmitting the extracted guideline to the user, information transmitted to the user may include a standard happy factor for each individual type, an individual happy factor, a relative/absolute position, for example, XXth among OO (a high rank of YY %), a balance/ideal management phase, a target factor, an increase/management guideline.

Also, according to the embodiment of the present invention, two feedback phases are provided twice to reflect a development degree of the user and the improvement and deterioration of an overall level.

That is, next to the guideline transmission operation S800, to update information for each happy factor area for each individual, the method includes a first feedback operation (S810) of updating the personal happy factor database 121 by receiving the individual information for each happy factor area again. Next to the standard database updating operation S1000, the method includes a second feedback operation (S1010) of comparing updated standard information with the input value.

Since the feedback operations are allowed to quickly reflect the development degree of the user and the improvement and deterioration of the overall level, the happy factor system may be more reliably and flexibly operated and may effectively reflect great changes in society.

According to the embodiments of the present invention, following effects are provided.

First, individual customized happy factor information is provided, thereby easily determining an individual level of happiness.

Second, it is possible to determine one's own happy level and an unhappy factor according to an individual customized happy factor guideline and to make provision thereof.

Third, a happy factor service system may contribute to an increase in actual happiness of a user by always providing newest information through continuous feedback and calculating and managing a reliable happy factor.

The embodiment of the present invention has been described with reference to the accompanying drawings. However, it is merely an example of various embodiments of the present invention and is to allow one of ordinary skill in the art to easily invent the same. It is obvious that the present invention is not limited to the embodiment described above. It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents. Also, sizes of some components in the drawings may be exaggerated or reduced than real sizes for convenience of explanation.

What is claimed is:

1. A happy factor service system comprising a happy factor management server and a plurality of personal terminals connected thereto through a wired or wireless communication network, wherein the happy factor management server comprises:
an information input module;
a database module which stores data obtained from the information input module and each module and provides data necessary for each module;
a data analyzing module which analyzes the information obtained from the information input module;
a happy factor extraction module which extracts a happy factor from the data analyzed by the data analyzing module; and
a guideline generating module which compares the happy factor extracted by the happy factor extraction module with standard data and provides a guideline.

2. The happy factor service system of claim 1, wherein the information input module comprises:
an individual information input unit for inputting basic information of an individual such as gender and age of a person; and
a happy factor area input unit for inputting information for each happy factor area.

3. The happy factor service system of claim 1, wherein the database module comprises:
a personal happy factor database which stores the individual basic information obtained from the individual information input unit and the information for each happy factor area obtained from the happy factor area input unit; a standard database which stores previously built standard information; and
a data updating unit for updating the respective databases.

4. The happy factor service system of claim 1, wherein the data analysis module comprises:
an individual type analysis unit which analyzes an individual type based on data obtained from the individual information input unit; a happy factor area index analysis unit which analyzes an index for each happy factor area based on data obtained from the happy factor area input unit; and
a happy factor area weight draw unit for giving a weighted value according to an analysis result of the individual type analysis unit to the index for each happy factor area analyzed by the happy factor area index analysis unit.

5. The happy factor service system of claim 4, wherein the happy factor extraction module comprises:
a happy factor extraction unit which extracts a happy factor by reflecting a result of the happy factor area weight draw unit in the analysis result of the individual type analysis unit; and
a management phase calculation unit for obtaining a management reference of the extracted happy factor.

6. The happy factor service system of claim 1, wherein the guideline generation module comprises:
a significant happy factor area calculation unit which calculates a significant happy factor area based on results from the happy factor area weight draw unit and the management phase calculation unit;
a happy factor area guideline generation unit which compares a result of the happy factor extraction unit with data selected from the standard database for each area calculated by the significant happy factor area calculation unit and generating a guideline for each happy factor area; and
a phase guideline generation unit which generates a guideline for each phase by comparing a management reference obtained from the management phase calculation unit with the data selected from the standard database.

7. The happy factor service system of claim 2, wherein the information for happy factor area comprises at least one of a social happy factor, an occupational happy factor, a spiritual happy factor, a physical happy factor, an intellectual happy factor, an emotional happy factor, an environmental happy factor, a financial happy factor, a mental happy factor, and a medical happy factor.

8. A method of providing a happy factor service using a happy factor service system comprises:
an information receiving operation of receiving information input for each happy factor area;
a standard information comparison operation of comparing information of a standard database with an input value;
an individual classification operation of classifying types of individuals according to inputted individual information;
a weighted value calculation operation of giving a weighted value to each happy factor area according to a classified individual type;
a happy factor extraction operation of extracting a happy factor according to the classified individual type and a calculated weighted value for each area;
a management phase determination operation of determining an appropriate management phase by comparing the extracted happy factor with standard information of the standard information database of the database module;
a guideline extraction operation of extracting a customized guideline according to the extracted happy factor and the determined management phase;
a guideline transmission operation of transmitting the extracted guideline to the user;
a personal happy factor information storage operation of storing personal happy factor information in the personal happy factor database; and
a standard database updating operation of updating the standard database by reflecting the stored personal happy factor information.

9. The method of claim 8, comprising, next to the guideline transmission operation, a first feedback operation of receiving the information for each happy factor area for individual again to update the information for each happy factor area for each individual.

10. The method of claim 8, comprising, next to the standard database updating operation, a second feedback operation of comparing updated standard information with the input value.

11. The method of claim 8, comprising, next to the guideline transmission operation, a first feedback operation of receiving the information for each happy factor area for individual again to update the information for each happy factor area for each individual, and
next to the standard database updating operation, a second feedback operation of comparing updated standard information with the input value.
